(19) United States
(12) Patent Application Publication
(10) Pub. No.: US 2015/0127429 A1
(43) Pub. Date: May 7, 2015

(54) EXPECTATION PRICE PROVIDING SYSTEM OF USED CAR AND METHOD THEREOF

(71) Applicant: HYUNDAI MOTOR COMPANY, Seoul (KR)

(72) Inventors: Seon Su KIM, Seongnam-Si (KR); Seung-Chang PARK, Seoul (KR)

(73) Assignee: HYUNDAI MOTOR COMPANY, Seoul (KR)

(21) Appl. No.: 14/285,451

(22) Filed: May 22, 2014

(30) Foreign Application Priority Data
Nov. 6, 2013 (KR) 10-2013-0134413

(51) Int. Cl. G06Q 30/02

(52) U.S. Cl. CPC G06Q 30/0283
USPC 705/7.35

(57) ABSTRACT

An expectation price providing system of a used car, which is connected with a vehicle terminal, an insurance company system, and a maintenance shop terminal system through a network, and a method thereof are provided. The system includes a database which stores part state information, driving information, maintenance information, a model, and accident detail information of a vehicle. A server receives accident information of the vehicle from the insurance company system, receives the maintenance information of the vehicle from the maintenance shop terminal system, receives the driving information from the vehicle terminal, reads a basic current used car price corresponding to the model and mileage of the vehicle from the database, and corrects and provides basic current used car price information by referring to the part state information, the maintenance information, and the accident detail information of the vehicle.

### CROSS-REFERENCE TO RELATED APPLICATION

This application claims the benefit of priority to Korean Patent Application No. 10-2013-0134413 filed in the Korean Intellectual Property Office on Nov. 6, 2013, the entire contents of which are incorporated herein by reference.

### BACKGROUND

The present disclosure relates to an expectation price providing system of a used car and a method thereof, and more particularly, to an expectation price providing system of a used car and a method thereof which analyze vehicle data and provide an expected used car price based on the analyzed vehicle data.

### TECHNICAL FIELD

In general, a vehicle is purchased at a current price by using an off-line used car market, or a used car is purchased on-line by referring to an on-line current price of the used car. However, the current price of the used car is decided based on a model or the like, and an actual state of the vehicle cannot be accurately reflected on the current price of the used car.

In recent years, the current price of the used car has been affected by accident information or the like, and mileage or the like has been additionally reflected. However, there are a lot of frauds in which the mileage may be fabricated here, and an accurate part state or accurate driving information of the vehicle may not be reflected. Further, an abrasion degree of the part varies depending on maintenance in spite of the same model for each vehicle, and the state of the vehicle also varies due to a variable driving area or time. Therefore, information on the current price of the used car on which the information is reflected needs to be provided to a consumer.

A technology in which an auction is progressed by expecting automatic fluctuation in a current price of a used car is disclosed in Korean Patent No. 1061094, but the technology is similar to the existing content of expecting fluctuation in the current price of the used car, and does not reflect an accurate part state or driving information of a vehicle.

The above information disclosed in this Background section is only for enhancement of understanding of the background of the disclosure, and therefore, it may contain information that does not form the prior art that is already known in this country to a person of ordinary skill in the art.

### SUMMARY

The present disclosure has been made in an effort to provide drives with price information of a used car on which maintenance information, vehicle sensor information, and driving information of a vehicle are reflected.

An aspect of the present disclosure provides information on a current price of a used car on which accurate driving information, maintenance information, and sensor information of a vehicle is reflected to a driver in order to reduce time, and to select a reliable used car which is suitable for the driver or sell the used car at a right sale price. Further, the present disclosure has been made in an effort to allow a car maker to consider drivers.

An exemplary embodiment of the present disclosure provides an expectation price providing system of a used car, which is connected with a vehicle terminal, an insurance company system, and a maintenance shop terminal system through a network. The system includes a database which stores part state information, driving information, maintenance information, a model, and accident detail information of a vehicle. A server receives the accident information of the vehicle from the insurance company system, receives the maintenance information of the vehicle from the maintenance shop terminal system, and receives the driving information from the vehicle terminal. The server reads a basic current used car price corresponding to the model and mileage of the vehicle from the database, and corrects and provides basic current used car price information by referring to the part state information, the maintenance information, and the accident detail information of the vehicle.

The database may include a part state information database of the vehicle which stores the vehicle model and state information of components constituting the vehicle. A driving information database stores the driving information including the mileage of the vehicle. A maintenance information database stores maintenance history information of the vehicle. An accident detail information database stores the accident detail information of the vehicle.

The part state information database of the vehicle may store information representing a deterioration degree corresponding to a part of the vehicle.

The deterioration degree corresponding to the part of the vehicle may be decided as an average customer comparison value or decided by using a durability prediction curve at the time of designing the part.

An expected used car price car may be decided by applying a weight of each vehicle part.

The expected used car price may be acquired by summing up values acquired by multiplying a value, which is acquired by multiplying a reference value-to-index representing the deterioration degree of the part by the weight of each vehicle part, by an average price for each part.

The server may provide the expected used car price added with a cost corresponding to a maintenance detail or an accident detail as an additional correction value.

According to another exemplary embodiment of the present disclosure, an expectation price providing a method of a used car in an expectation price providing system of the used car, which includes a database that stores part state information, driving information, maintenance information, a model, and accident detail information of a vehicle, and is connected with a vehicle terminal, an insurance company system, and a maintenance shop terminal system through a network. The method includes receiving the accident information of the vehicle from the insurance company system and storing the received accident information in the database by a server. The maintenance information of the vehicle is received from the maintenance shop terminal system and stores the received maintenance information in the database. A basic current used car price corresponding to the model and mileage of the vehicle are read from the database, correcting basic current used car price information by referring to the part state information, the maintenance information, and the accident detail information of the vehicle, and creating and providing an expectation price of the used car.

In the creating and providing of the expected used car price, the expected used car price may be acquired by summing up values acquired by multiplying a value, which is acquired by multiplying a reference value-to-index representing a deterioration degree of a vehicle part by a weight of each vehicle part, by an average price for each part.

The server may provide the expected used car price added with a cost corresponding to a maintenance detail or an accident detail as an additional correction value.

The deterioration degree corresponding to the part of the vehicle may be decided as an average customer comparison value or decided by using a durability prediction curve at the time of designing the part.

According to exemplary embodiments of the present disclosure, it is possible to allow a driver to reduce time by providing the driver with information on the current price of the used car on which accurate driving information, maintenance information, and sensor information of the vehicle is reflected, and to select a reliable used car which is suitable for the driver, or sell the used car at a right sale price. Further, it is possible to allow a car maker to consider drivers.

### BRIEF DESCRIPTION OF THE DRAWINGS

FIG. 1 is a configuration diagram of an expectation price providing system of a used car according to an exemplary embodiment of the present disclosure.

FIG. 2 is an operation flowchart of an expectation price providing a method of a used car according to an exemplary embodiment of the present disclosure.

FIG. 3 is a table illustrating an example of calculating an expectation price of a used car in the expectation price providing system of the used car according to an exemplary embodiment of the present disclosure.

FIG. 4 is a configuration diagram in the expectation price providing system of a used car according to an exemplary embodiment of the present disclosure.

### DETAILED DESCRIPTION

Hereinafter, exemplary embodiments of the present disclosure will be described in detail with reference to the accompanying drawings. As those skilled in the art would realize, the described embodiments may be modified in various different ways, all without departing from the spirit or scope of the present disclosure. Further, each configuration illustrated in the drawings is arbitrarily shown for understanding and ease of description, but the present disclosure is not limited thereto.

Hereinbelow, an independent function key means that a request function is executed as well as a function key is executed, and a dependent function key means that a requested function is executed when a specific condition is satisfied.

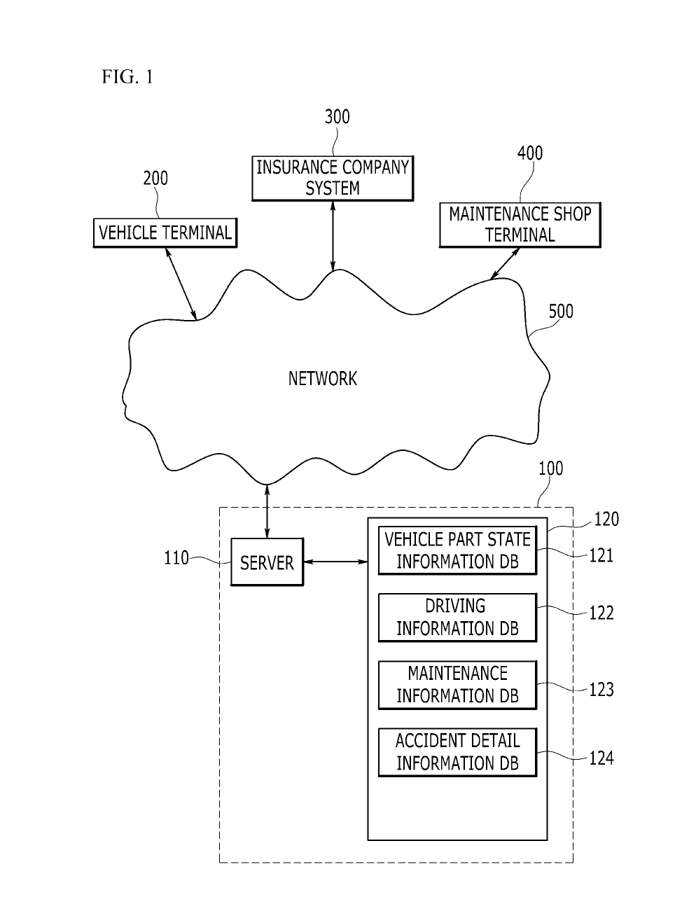

FIG. 1 is a configuration diagram of an expectation price providing system of a used car according to an exemplary embodiment of the present disclosure.

Referring to FIG. 1, an expectation price providing system 100 of a used car according to an exemplary embodiment of the present disclosure is connected with a vehicle terminal 200, an insurance company system 300, and a maintenance shop terminal system 400 through a network 500. The system 100 includes a database 120 which stores part state information, driving information, maintenance information, a model, and accident detail information of a vehicle. A server 110 receives the accident information of the vehicle from the insurance company system, receives the maintenance information of the vehicle from the maintenance shop terminal system, and receives the driving information from the vehicle terminal. The server 110 then reads a basic current used car price corresponding to the model and mileage of the vehicle from the database 120, and provides basic current used car price information by referring to the part state information, the maintenance information, and the accident detail information of the vehicle.

The database 120 includes a part state information database 121 of the vehicle which stores the model of the vehicle and state information of components constituting the vehicle. A driving information database 122 stores the driving information including the mileage of the vehicle. A maintenance information database 123 stores maintenance history information of the vehicle. An accident detail information database 124 stores the accident detail information of the vehicle. The part state information database 121 of the vehicle may store information representing a deterioration degree corresponding to the part of the vehicle. The deterioration degree corresponding to the part of the vehicle may be decided as an average customer comparison value or decided by using a predetermined durability prediction curve at the time of designing the part.

The expected used car price may be decided by applying a weight for each part. The expected used car price may be acquired by summing up values acquired by multiplying a value, which is acquired by multiplying a reference value-to-index representing the deterioration degree of the part by the weight of each part, by an average price for each part. The server 110 may provide the expected used car price added with cost corresponding to a maintenance detail or an accident detail as an additional correction value.

An operation of the expectation price providing system of a used car according to an exemplary embodiment of the present disclosure, which has the above configuration, will be described below.

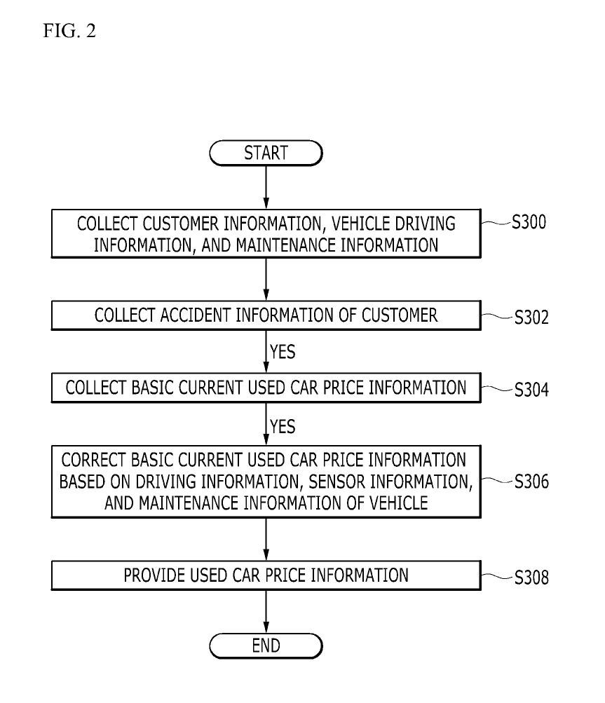

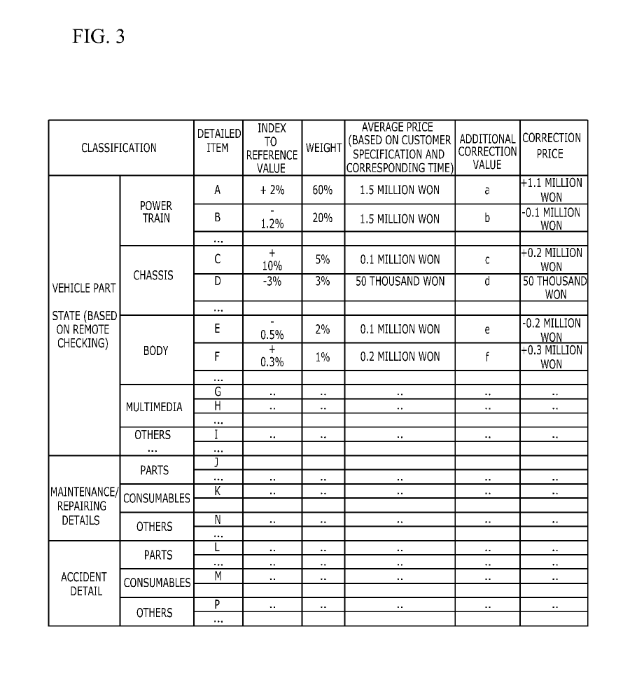

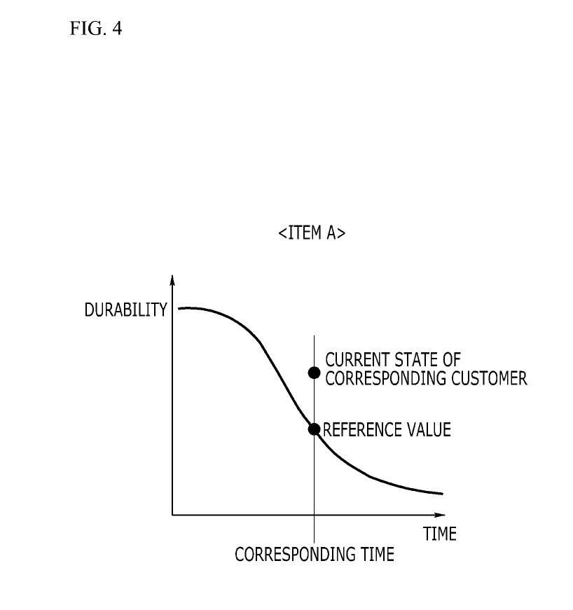

FIG. 2 is an operation flowchart of an expectation price providing a method of a used car according to an exemplary embodiment of the present disclosure. FIG. 3 is a table illustrating an example of calculating an expectation price of a used car in the expectation price providing system of the used car according to an exemplary embodiment of the present disclosure. FIG. 4 is a configuration diagram in the expectation price providing system of a used car according to an exemplary embodiment of the present disclosure.

Referring to FIG. 2, a vehicle transmits part state information (sensor checking value) and driving information of the vehicle to a center server 110 of a terminal 200 of the vehicle at a predetermined cycle, and the server 110 stores the received information in a vehicle part state information database 120, when the vehicle stops, in order to provide drivers with information on an expectation price of a used car on which maintenance information, sensor information, and driving information of the vehicle are reflected.

Then, the server 110 stores the driving information in a driving information database 122. In this case, the received information is stored for each vehicle, and the vehicle part state information corresponding to basic information of the vehicle is stored.

Further, the server 110 receives maintenance information of the vehicle from the maintenance shop terminal system 400 and stores the received information in a maintenance information database 123 (S300). In addition, accident information is received by the center server 110 together with vehicle information whenever the accident information is generated, through an insurance company system 300, and the server 110 stores the accident information in an accident information database 124 (S302).

Therefore, the center server 110 periodically updates the accident information, the driving information, and the maintenance information for each customer and has monitoring values (deterioration and durability degrees) for primary part states of the vehicle. In this state, the server 110 receives a basic current used car price corresponding to a model and mileage of the vehicle from the outside or stores the basic current used car price beforehand in an internal database 120, and thereafter reads the stored basic current used car price according to a request from the vehicle terminal 200 of the customer or other terminals, such as a PC, which are accessible to a network 500 (S304).

Then, the server 110 creates and provides an expected used car price by correcting the basic current used car price information by referring to the part state information, the maintenance information, and the accident detail information of the vehicle (S306 and S308). After an expected used car price is created beforehand as necessary, the created price may be provided according to an external request or the expected used car price may be created and provided upon every request.

A process of deciding the expected used car price in such a process will be described in detail.

First, the server 110 receives a first start price from the outside or brings the first start price from the database 120 in link with the model, the mileage, and a basic used car price by the model. In addition, the server 110 corrects the first start price by reflecting the driving information, the vehicle part information, and the maintenance information on the first start price. In detail, as illustrated in FIG. 3, parts are divided into power train, chassis, body, multimedia fields, and the like, a weight is applied for each part of each field, and a total sum of the weights is set to 100%.

In addition, an index is given to each part according to a deterioration degree to a reference value. The index may also be given by other methods as necessary, and as a decrepit degree of the part is lower, a larger index is given. Further, an average price for each part is based on a corresponding time by considering a specification or a model of a customer vehicle as a start price. Moreover, an additional correction value may be reflected based on an accident detail or a maintenance/repairing detail or information on other driving areas, for example, a coastal area or a dusty area.

A final correction price for each part may be simply expressed by an equation described below.

Final correction price for each part=index to reference value×weight×average price+additional correction value (Equation 1)

In addition, when final correction prices of respective parts items are totaled, the expected used car price at the corresponding time is calculated.

Herein, a reference durability value for each influence factor is stored in the vehicle part state information database 121 based on the center server 110. The reference durability value may be set as an average customer comparison value or an expected durability curve at the time of designing. An example of the curve is illustrated in FIG. 4. Referring to FIG. 4, durability decreases with the curve of FIG. 4, and the value thereof also decreases as time elapses.

In addition, it is possible to improve reliability for the customer through issuing a warranty by a car maker with respect to a primary correction value and a durability degree, a repairing history, and the like as necessary.

The calculation equation may be variously modified, and a method of reflecting the maintenance information, the sensor information, and the driving information of the vehicle to the current price of the used car may be variously modified.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. An expectation price providing system of a used car, which is connected with a vehicle terminal, an insurance company system, and a maintenance shop terminal system through a network, the system comprising:
a database which stores part state information, driving information, maintenance information, a model, and accident detail information of a vehicle; and
a server which receives the accident detail information of the vehicle from the insurance company system, receives the maintenance information of the vehicle from the maintenance shop terminal system, receives the driving information from the vehicle terminal, reads a basic current used car price corresponding to the model and mileage of the vehicle from the database, and corrects and provides basic current used car price information by referring to the part state information, the maintenance information, and the accident detail information of the vehicle.

2. The system of claim 1, wherein the database includes:
a part state information database of the vehicle which stores the model of the vehicle and state information of components constituting the vehicle;
a driving information database which stores the driving information including the mileage of the vehicle;
a maintenance information database which stores maintenance history information of the vehicle; and
an accident detail information database which stores the accident detail information of the vehicle.

3. The system of claim 2, wherein
the part state information database of the vehicle stores information representing a deterioration degree corresponding to a part of the vehicle.

4. The system of claim 3, wherein
the deterioration degree corresponding to the part of the vehicle is decided as an average customer comparison value or decided by using a durability prediction curve at the time of designing the part.

5. The system of claim 4, wherein
an expected used car price is decided by applying a weight of each part.

6. The system of claim 5, wherein
the expected used car price is acquired by summing up values acquired by multiplying a value, which is acquired by multiplying a reference value-to-index representing the deterioration degree of the part by the weight of each part, by an average price for each part.

7. The system of claim 6, wherein
the server provides the expected used car price added with a cost corresponding to a maintenance detail or an accident detail as an additional correction value.

8. A expectation price providing a method of a used car in an expectation price providing system of the used car, which includes a database that stores part state information, driving information, maintenance information, a model, and accident detail information of a vehicle, and is connected with a vehicle terminal, an insurance company system, and a maintenance shop terminal system through a network, the method comprising steps of:
receiving, by a server, the accident information of the vehicle from the insurance company system and storing the received accident information in the database;
receiving the maintenance information of the vehicle from the maintenance shop terminal system and storing the received maintenance information in the database; and
reading a basic current used car price corresponding to the model and mileage of the vehicle from the database, correcting basic current used car price information by referring to the part state information, the maintenance information, and the accident detail information of the vehicle, and creating and providing an expected used car price.

9. The method of claim 8, wherein
in the step of creating and providing the expected used car price,
the expected used car price is acquired by summing up values acquired by multiplying a value, which is acquired by multiplying a reference value-to-index representing a deterioration degree of a vehicle part by a weight of each vehicle part, by an average price for each part.

10. The method of claim 9, wherein
the server provides the expected used car price added with a cost corresponding to a maintenance detail or an accident detail as an additional correction value.

11. The method of claim 10, wherein
the deterioration degree corresponding to the part of the vehicle is decided as an average customer comparison value or decided by using a durability prediction curve at the time of designing the part.
